(19) United States
(12) Patent Application Publication
(10) Pub. No.: US 2018/0105012 A1
(43) Pub. Date: Apr. 19, 2018

(54) AIR CONDITIONER FOR VEHICLE

(71) Applicant: DENSO CORPORATION, Kariya-city, Aichi-pref. (JP)

(72) Inventors: Shuzo ODA, Kariya-city (JP); Shouichi IMAHIGASHI, Kariya-city (JP)

(21) Appl. No.: 15/567,420

(22) PCT Filed: Apr. 19, 2016
(86) PCT No.: PCT/JP2016/002087

§ 371 Date: Oct. 18, 2017

(30) Foreign Application Priority Data
Apr. 28, 2015 (JP) 2015-091133

(51) Int. Cl. B60H 1/00

(52) U.S. Cl. CPC B60H 1/00064; B60H 2001/006; B60H 2001/00099; B60H 2001/00135; B60H 1/00849

(57) ABSTRACT

The air conditioner for a vehicle has a centrifugal fan and a housing. The centrifugal fan has a fan suction port and a rotary shaft and rotates centering on a rotational axis of the rotary shaft. The housing has a fan housing chamber, an introduction passage, and a wall. The fan housing chamber houses the centrifugal fan. The introduction passage guides air, which flows from an outside of the housing into the housing, to flow toward the centrifugal fan in a first direction intersecting with the rotational axis. The wall partitions the fan housing chamber and the introduction passage from each other and has an opening that faces the fan suction port. The wall has a rim defining the opening and being provided with an annular protruding portion. The annular protruding portion protrudes from the wall toward the introduction passage and covers the opening.

### CROSS REFERENCE TO RELATED APPLICATION

This application is based on and claims the benefit of priority from Japanese Patent Application No 2015-091133 filed on Apr. 28, 2015. The entire disclosure of the application is incorporated herein by reference.

### TECHNICAL FIELD

The present disclosure relates to an air conditioner for a vehicle.

### BACKGROUND ART

An air conditioner for a vehicle is known to have a centrifugal fan and a housing. The centrifugal fan draws air in a direction along a rotational axis. The housing houses the centrifugal fan. The housing defines a passage therein. When the centrifugal fan rotates, a negative pressure is caused and thereby air is drawn into the passage from an outside or an inside of a vehicle compartment.

Air conditioning devices such as an evaporator and a heater core are positioned in the passage of the housing. The air drawn into the passage passes through the air conditioning devices such that a temperature of the air is adjusted by the air conditioning devices, and then is blown into the vehicle compartment. Regarding such an air conditioner for a vehicle, it is considered to reduce noise caused when the air is drawn and to reduce a flow resistance in the passage.

Then, Patent Literature 1 discloses an air conditioner that has a guide member located at a position corresponding to a position of a suction port of a centrifugal fan. The guide member has a conical shape and protrudes toward the suction port of the centrifugal fan. The guide member adjusts a flow of the air drawn into a passage defined in a housing such that the air flows to the suction port of the centrifugal fan smoothly. As a result, the noise and the flow resistance can be suppressed.

According to the air conditioner disclosed in Patent Literature 1, the housing has a cube shape having two sides facing to each other, and the two sides draws the air. Since the air flows into the suction port of the centrifugal fan from two directions, a flow velocity distribution of the air in the suction port can be uniform.

### PRIOR ART LITERATURES

### Patent Literature

Patent Literature 1: JP 2008-241143 A

### SUMMARY OF INVENTION

In recent years, devices mounted in a vehicle are required to be downsized, and an air conditioner for a vehicle is not an exception, either. Accordingly, it may be difficult to configure a passage to supply air to a suction port of a centrifugal fan from another direction.

According to studies conducted by the inventors of the present disclosure, there is no difficulty to supply air to a centrifugal fan from one direction as long as the direction is along a rotational axis of the centrifugal fan. However, in a case where the direction intersects with the rotational axis of the centrifugal fan, a flow speed of the air may increase locally in the suction port of the centrifugal fan. As a result, an abnormality that noise is caused in the suction port and that a flow resistance in the passage increases may occur.

The present disclosure addresses the above-described issues, and it is an objective of the present disclosure to provide an air conditioner for a vehicle that is compact and is configured to suppress occurrences of a noise and a flow resistance in a passage.

An air conditioner for a vehicle according to the present disclosure has a centrifugal fan and a housing. The centrifugal fan has a fan suction port and a rotary shaft and rotates centering on a rotational axis of the rotary shaft. The centrifugal fan draws air from the fan suction port along the rotational axis and blows the air in a radial direction. The housing has a fan housing chamber, an introduction passage, and a wall. The fan housing chamber houses the centrifugal fan. The introduction passage guides air, which flows from an outside of the housing into the housing, to flow toward the centrifugal fan in a first direction intersecting with the rotational axis. The wall partitions the fan housing chamber and the introduction passage from each other and has an opening that faces the fan suction port. The wall has a rim defining the opening and having an annular protruding portion. The annular protruding portion protrudes from the wall toward the introduction passage and covers the opening.

According to the present disclosure, the air from the outside is guided to flow in the first direction intersecting with the rotational axis and is introduced to the centrifugal fan. In this case, a flow speed of the air may increase locally in a portion defining an upstream portion of the suction port in the first direction.

Then, according to the present disclosure, the wall has the rim defining the opening and having the annular protruding portion. The annular protruding portion protrudes from the wall toward the introduction passage and covers the opening. Accordingly, the air flows in the introduction passage around the annular protruding portion and is distributed around the opening, thereby flowing to a downstream portion of the opening in the first direction. As a result, the flow speed of the air can be prevented from increasing locally in the opening and the fan suction port, whereby noise and a flow resistance can be suppressed.

Thus, the present disclosure can provide an air conditioner for a vehicle that is compact and is configured to suppress occurrences of noise and a flow resistance in a passage.

### BRIEF DESCRIPTION OF DRAWINGS

The above and other objects, features and advantages of the present disclosure will become more apparent from the following detailed description made with reference to the accompanying drawings.

FIG. 1 is a diagram illustrating a cross sectional view of an air conditioner for a vehicle according to an embodiment of the present disclosure.

FIG. 2 is an enlarged diagram illustrating a first centrifugal fan illustrated in FIG. 1 and a peripheral area of the first centrifugal fan.

FIG. 3 is a cross sectional view taken along a line III-III shown in FIG. 1.

FIG. 4 is a diagram illustrating a cross sectional view of an air conditioner for a vehicle according to a modification of the embodiment.

### DESCRIPTION OF EMBODIMENTS

An embodiment of the present disclosure will be described hereinafter referring to drawings. The same component is assigned with the same reference number in the drawings, and a redundant explanation will be omitted, such that the following description can be understood easily.

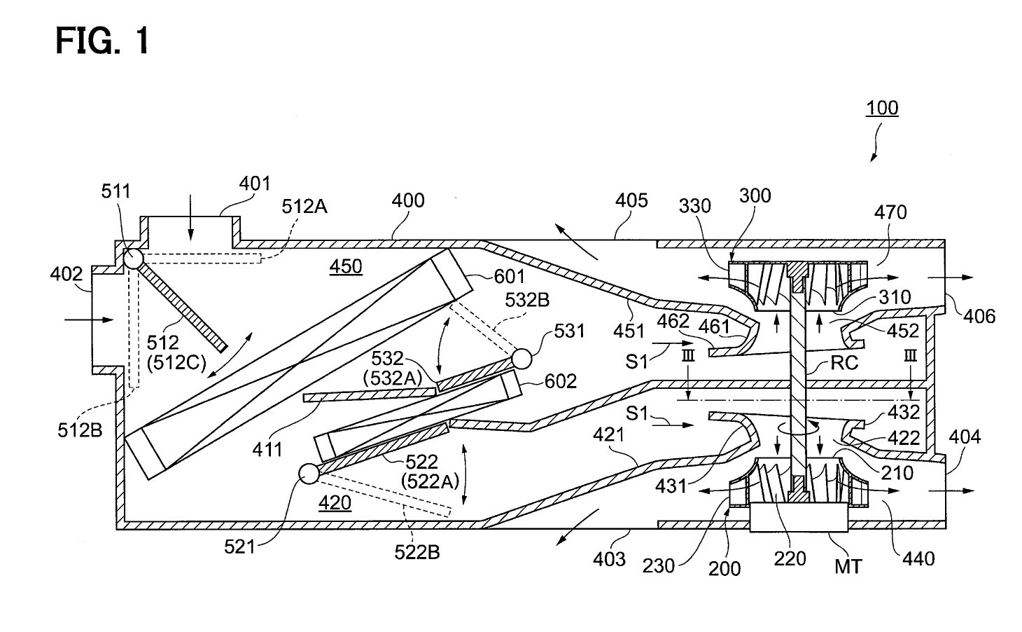

An air conditioner 100 for a vehicle according to the embodiment of the present disclosure will be described hereafter referring to FIG. 1.

The air conditioner 100 for a vehicle, referred to as the air conditioner 100 hereafter, is a device used in the vehicle to adjust a temperature of a vehicle compartment (not shown). As shown in FIG. 1, the air conditioner 100 has a housing 400, a first centrifugal fan 200, a second centrifugal fan 300, an evaporator 601, and a heater core 602.

The housing 400 is a member serving as a casing of the air conditioner 100 and is made of resin material. The housing 400 has a partition wall 411 therein. The partition wall 411 divides an inside of the housing 400 into a first introduction passage 420 and a second introduction passage 450 in an up-down direction.

The housing 400 has an upper wall and a lower wall facing each other in the up-down direction and sidewalls facing each other in a direction perpendicular to the up-down direction. The housing 400 has an outside air inlet 401 and an inside air inlet 402. The outside air inlet 401 is provided in the upper wall. The upper wall has one end and an other end in the direction and has a center located between the one end and the other end in the direction. The outside air inlet 401 is located between the one end and the center in the direction. The inside air inlet 402 is provided in the one sidewall. The one sidewall has a center in the up-down direction. The inside air inlet 402 is located between the one end of the upper wall and the center of the one sidewall in the up-down direction. An air (i.e., outside air), which flows from an outside of the vehicle compartment, flows into the housing 400 from the outside air inlet 401. An air (i.e., inside air), which flows from an inside of the vehicle compartment, flows into the housing 400 from the inside air inlet 402.

The housing 400 has a first fan housing chamber 440 and a second fan housing chamber 470. The first fan housing chamber 440 is a space defined in the housing 400 by being divided from the first introduction passage by a first wall 421. The first fan housing chamber 440 is located adjacent to the lower wall of the housing 400 in the up-down direction and adjacent to the other sidewall of the housing 400 in the direction. The first wall 421 has a first opening 422 having a circular shape in cross section. The first introduction passage 420 and the first fan housing chamber 440 communicate with each other through the first opening 422. The second fan housing chamber 470 is a space defined in the housing 400 by being divided from the second introduction passage by a second wall 451. The second fan housing chamber 470 is located adjacent to the upper wall of the housing 400 in the up-down direction and adjacent to the other sidewall of the housing 400 in the direction. The second wall 451 has a second opening 452 having a circular shape in cross section. The second introduction passage 450 and the second fan housing chamber 470 communicate with each other through the second opening 452.

The housing 400 has a first air outlet 403 and a second air outlet 404. The first air outlet 403 is defined in the lower wall and located adjacent to the other sidewall. The second air outlet 404 is defined in the other sidewall and located adjacent to the lower wall. The first fan housing chamber 440 communicates with an outside of the housing 400 through the first air outlet 403 and the second air outlet 404. The housing 400 further has a third air outlet 405 and a fourth air outlet 406. The third air outlet 405 is defined in the upper wall and located adjacent to the other sidewall. The fourth air outlet 406 is defined in the other sidewall and located adjacent to the upper wall. The second fan housing chamber 470 communicates with the outside of the housing 400 through the third air outlet 405 and the fourth air outlet 406.

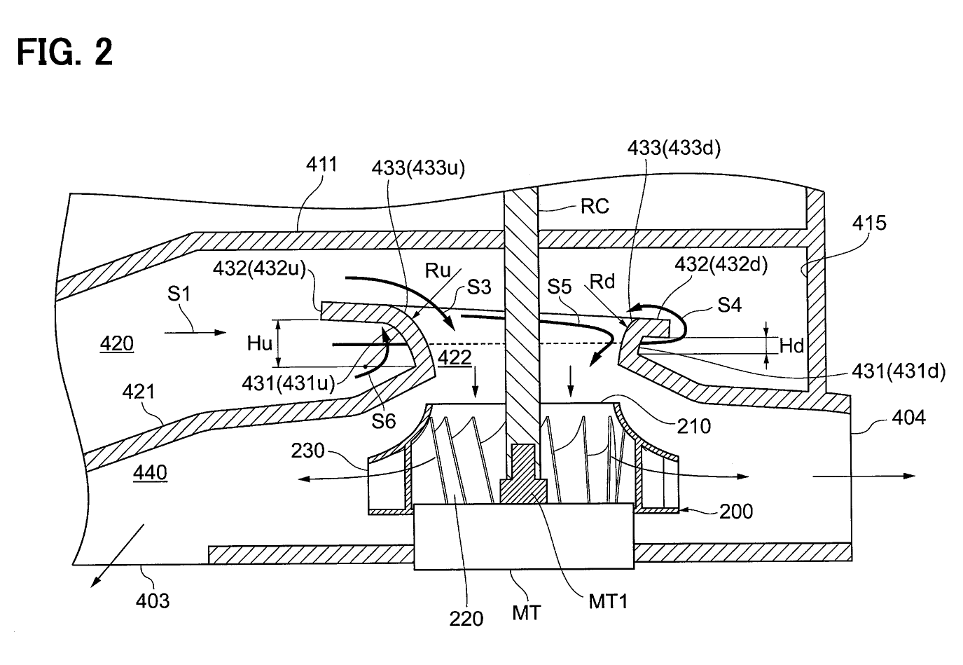

The first centrifugal fan 200 is housed in the first fan housing chamber 440 of the housing 400 such that a fan suction port 210 of the first centrifugal fan 200 faces the first opening 422 of the first wall 421. The first centrifugal fan 200 has blades 220 having a curved shape and being arranged at regular intervals. The first centrifugal fan 200 has a fan outlet 230 opening to an outside of the first centrifugal fan 200 in a radial direction. The first centrifugal fan 200 has a rotary shaft RC having a rotational axis. The first centrifugal fan 200 rotates centering on the rotational axis. The rotary shaft RC is fixed to an output shaft MT1 (refer to FIG. 2) of a motor MT.

The second centrifugal fan 300 is housed in the second fan housing chamber 470 of the housing 400. The second centrifugal fan 300 has a similar shape as the first centrifugal fan 200. The second centrifugal fan 300 has a fan suction port 310 and a fan outlet 330. The fan suction port 210 faces the second opening 452 defined in the second wall 451. The fan outlet 330 opens to an outside of the second centrifugal fan 300 in the radial direction. The rotary shaft RC is inserted to both the first opening 422 and the second opening 452 and passes through the first wall 421 (i.e., a partition wall). The second centrifugal fan 300 is fixed to the rotary shaft RC.

The evaporator 601 is located in an upstream area of the housing 400 and extends across the first introduction passage 420 and the second introduction passage 450. The evaporator 601 has a one surface and an other surface facing each other. The air flows into the evaporator 601 from the one surface and flows out of the evaporator 601 from the other surface. That is, the evaporator 601 is configured to be capable of guiding the air to pass through an inside of the evaporator 601. The evaporator 601 is known to serve as a cooling heat exchanger cooling and drying the air passing through the evaporator 601 in a manner that the evaporator 601 causes a low-pressure refrigerant, which circulates in a refrigeration cycle (not shown), to absorb heat from the air and evaporate.

The heater core 602 is positioned to pass through the partition wall 411 and extend across the first introduction passage 420 and the second introduction passage 450. The heater core 602 has a one surface and an other surface facing each other. The air flows into the heater core 602 from the one surface and flows out of the heater core 602 from the other surface. That is, the heater core 602 is configured to be capable of guiding the air to pass through an inside of the heater core 602. A cooling water, which has a high temperature by cooling an engine (not shown) used in the vehicle, flows inside the heater core 602. The heater core 602 is a heating heat exchanger that heats the air passing through the heater core 602 using the cooling water as a heat source.

An inside/outside air door 512, a first door 522, and a second door 532 are arranged inside the housing 400.

The inside/outside air door 512 is positioned upstream of the evaporator 601. The inside/outside air door 512 has an end portion connected to a hinge 511. The inside/outside air door 512 rotates around the hinge 511 between a first position 512A and a second position 512B shown by a dashed line in FIG. 1. The inside/outside air door 512 closes an outside air inlet 410 and opens the inside air inlet 402 when being located at the first position 512A. The inside/outside air door 512 opens the outside air inlet 410 and closes the inside air inlet 402 when being located at the second position 512B. The inside/outside air door 512 opens both the outside air inlet 410 and the inside air inlet 402 when being located at a third position 512C between the first position 512A and the second position 512B.

The first door 522 is located downstream of the heater core 602 in the first introduction passage 420. The first door 522 has an end portion connected to a hinge 521. The first door 522 rotates around the hinge 521 between a first position 522A and a second position 522B shown by a dashed line in FIG. 1. The heater core 602 has a downstream end located in the first introduction passage 420. The first door 522 closes the downstream end when being located at the first position 522A. The first door 522 opens the downstream end when being located at the second position 522B.

The second door 532 is located upstream of the heater core 602 in the second introduction passage 450. The second door 532 has an end portion connected to a hinge 531. The second door 532 rotates around the hinge 531 between a first position 532A and a second position 532B shown by a dashed line in FIG. 1. The heater core 602 has an upstream end located in the second introduction passage 450. The second door 532 closes the upstream end when being located at the first position 532A. The second door 532 opens the upstream end when being located at the second position 532B.

According to the air conditioner 100 having the above-described configuration, the first centrifugal fan 200 and the second centrifugal fan 300 rotate centering on the rotary shaft RC when electric power is supplied to the motor MT. The first centrifugal fan 200 and the second centrifugal fan 300 draws air through the first opening 422 and the second opening 452 respectively when rotating, thereby a negative pressure is caused in each of the first introduction passage 420 and the second introduction passage 450.

When the negative pressure is caused in the first introduction passage 420 and the second introduction passage 450, air flows into the housing 400 at least one of the outside air inlet 401 and the inside air inlet 402 depending on the inside/outside air door 512. The air is cooled and dried by passing through the evaporator 601, and then flows into the first introduction passage 420 and the second introduction passage 450.

The air, which flows into the first introduction passage 420 and the second introduction passage 450, passes through the heater core 602 or bypasses the heater core 602 depending on positions of the first door 522 and the second door 532.

That is, the air in the first introduction passage 420 flows to a downstream side of the heater core 602 without passing through the heater core 602 when the first door 522 is located at the first position 522A because the downstream end of the heater core 602 is closed. On the other hand, the air in the first introduction passage 420 flows to the downstream side of the heater core 602 while passing through the heater core 602 when the first door 522 is located at the second position 522B because the downstream end of the heater core is open.

The air in the second introduction passage 450 flows to the downstream side of the heater core 602 without passing through the heater core 602 when the second door 532 is located at the first position 532A because the upstream end of the heater core 602 is closed. On the other hand, the air in the second introduction passage 450 flows to the downstream side of the heater core 602 while passing through the heater core 602 when the second door 532 is located at the second position 532B because the upstream end of the heater core 602 is open.

When the air bypasses the heater core 602, the air flows to the downstream side while a temperature of the air is kept low. In contrast, when the air passes through the heater core 602, the air flows to the downstream side while the temperature of the air rises by exchanging heat with the cooling water having a high temperature.

On the downstream side of the heater core 602, the air flows in a direction S1 along the first wall 421 and the second wall 451 in the first introduction passage 420 and the second introduction passage 450 respectively. The direction S1 is a first direction intersecting with the rotational axis of the rotary shaft RC of the first centrifugal fan 200.

A directivity of the air flowing in the first introduction passage 420 along the direction S1 is adjusted by an annular protruding portion 431 and a flange 432, and then reaching the first opening 422 of the first wall 421. The air passes through the first opening 422 and is drawn into the fan suction port 210 of the first centrifugal fan 200, and then being blown from the fan outlet 230 into the first fan housing chamber 440. The air is blown from the first air outlet 403 and the second air outlet 404 to an outside of the housing 400.

A directivity of the air flowing in the second introduction passage 450 along the direction S1 is adjusted by an annular protruding portion 461 and a flange 462, and then reaching the second opening 452 of the second wall 451. The air passes through the second opening 452 and is drawn into the fan suction port 310 of the second centrifugal fan 300, and then being blown from the fan outlet 330 into the second fan housing chamber 470. The air is blown from the third air outlet 405 and the fourth air outlet 406 to an outside of the housing 400.

The air flowing from the first air outlet 403, the second air outlet 404, the third air outlet 405, and the fourth air outlet 406 is supplied to various areas such as an inner surface of a windshield of the vehicle and a head, torso, or foot of a passenger, through a duct (not shown) that defines a passage therein.

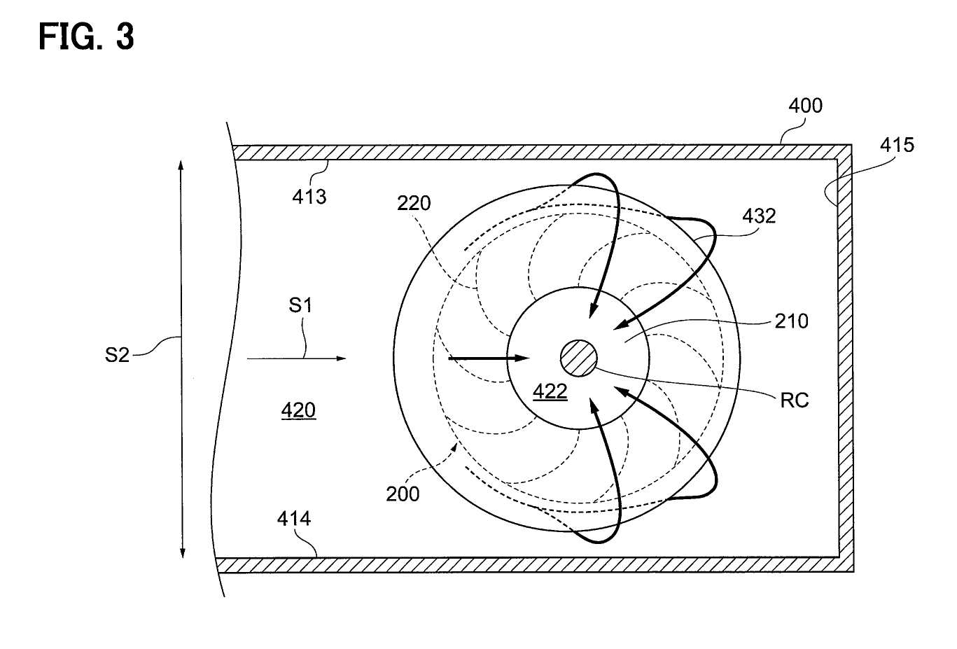

A configuration around the first opening 422 will be described hereafter referring to FIG. 2 and FIG. 3. A configuration around the second opening 452 is substantially symmetric to the configuration around the first opening 422 in the up-down direction, therefore a description thereof is omitted.

As shown in FIG. 2, the first wall 421 has a rim defining the first opening 422. The rim has the annular protruding portion 431 protruding into the first introduction passage 420 and covering the first opening 422. According to the present embodiment, the annular protruding portion 431 is formed integrally with the first wall 421, however not being limited to this example. For example, the annular protruding portion 431 may be formed separately from the first wall 421 and attached to the first wall 421 by a method such as adhesion.

The annular protruding portion 431 has an upstream portion 431u and a downstream portion 431d. The upstream portion 431u is located upstream of the downstream portion 431d in the first introduction passage 420. The downstream portion 431d is located downstream of the upstream portion 431u in the first introduction passage 420. The upstream portion 431u protrudes from the first opening 422 by a protruding amount Hu that is greater than a protruding amount Hd by which the downstream portion 431d protrudes from the first opening 422. The annular protruding portion 431 has an end part being located adjacent to the first introduction passage 420 and having a curved portion 433. The curved portion 433 has a curved shape in which curvature radiuses vary depending on positions of the curved portion. The curved portion 433 has an upstream portion 433u and a downstream portion 433d. The upstream portion 433u is located upstream of the downstream portion 433d in the first introduction passage 420. The downstream portion 433d is located downstream of the upstream portion 433u in the first introduction passage 420. A curvature radius Ru of the upstream portion 433u is greater than a curvature radius Rd of the downstream portion 433d.

The annular protruding portion 431 includes an end portion having the flange 432. The flange 432 is located to be distanced from the first wall 421. As shown in FIG. 3, the flange 432 protrudes from the annular protruding portion 431 in a direction away from the first opening 422 and has a substantially elliptical shape when in a top view. Specifically, according to the present embodiment, the flange 432 protrudes from the first opening 422 by a protruding amount, and the protruding amount of an upstream portion 432u of the flange 432 is greater than the protruding amount of a downstream portion 432d of the flange 432. The other sidewall has an inner wall surface 415 defining a downstream end of the first introduction passage 420. A void is defined between the inner wall surface 415 and the annular protruding portion 431 in the direction S1. The annular protruding portion 431 is arranged also to be distanced from an inner wall surface 413 and an inner wall surface 414, which define the first introduction passage 420, in a direction S2. The direction S2 is perpendicular to both the rotary shaft RC and the direction S1.

As shown in FIG. 2, a part of the air flowing in the first introduction passage 420 along the direction S1 flows between the partition wall 411 and the flange 432 and reaches the curved portion 433 as shown by an arrow S3, according to the configuration around the first opening 422. A part of the air reaching the curved portion 433 is introduced to the first opening 422 along a curved surface of the upstream portion 433u. The rest of the air reaching the curved portion 433 flows from the upstream portion 433u to the first opening 422 through the downstream portion 433d while being swirled above the curved portion 433.

A part of the air flowing in the first introduction passage 420 along the direction S1 flows to a space defined between the flange 432 and the first wall 421. The part of the air flows along an outer surface of the annular protruding portion 431 and reaches an downstream part of the first opening 422, which is a part of the first opening 422 adjacent to a downstream end of the first opening 422, as shown by an arrow S4. The part of the air flowing to the space defined between the flange 432 and the first wall 421 flows upward along a surface of the annular protruding portion 431 to traverse the annular protruding portion 431 as shown by an arrow S6. However, the flange 432 blocks the part of air flowing upward along the surface of the annular protruding portion 431, whereby the part of the air flows to the downstream side of the annular protruding portion 431 along the outer surface of the annular protruding portion 431.

As described above, the first opening 422 includes the rim having the annular protruding portion 431, which protrudes from the first wall 421 toward the first introduction passage 420 and covers the first opening 422, according to the present embodiment. Therefore, the air flows in the first introduction passage 420 and is distributed around the first opening 422 by flowing along the annular protruding portion 431, thereby flowing to the downstream part of the first opening 422 in the direction S1. As a result, a flow speed of the air can be prevented from increasing locally in the first opening 422 and the fan suction port 210, whereby noise and a flow resistance can be suppressed.

In addition, the flange 432 is provided to be distanced from the first wall 421 and to protrude from the annular protruding portion 431 in the direction away from the first opening 422 according to the present embodiment. Accordingly, the air flowing along the annular protruding portion 431 can be prevented from flowing into the first opening 422 by traversing the annular protruding portion 431. As a result, the flow speed of the air can be prevented from increasing locally in the first opening 422 and the fan suction port 210 by guiding the air to flow to the downstream part of the first opening 422 in the direction S1, whereby the noise and the flow resistance can be suppressed.

The annular protruding portion 431 has the end portion adjacent to the first introduction passage 420 and the end portion has the curved portion 433, according to the present embodiment. Accordingly, the air reaching the curved portion 433 is swirled around the rotary shaft RC and then flows to the downstream part of the first opening 422 in the direction S1. As a result, the flow speed of the air can be prevented from increasing locally in the first opening 422 and the fan suction port 210, whereby the noise and the flow resistance can be suppressed.

The curved portion 433 has the upstream portion 433u and the downstream portion 433d located in the first introduction passage 420, and the curvature radius Ru of the upstream portion 433u is greater than the curvature radius Rd of the downstream portion 433d. Since the flow speed of the air is relatively fast at the upstream portion 433u, a flow of the air is prevented from separating from the upstream portion 433u by setting the curvature radius Ru relatively large, whereby a turbulence of the air is suppressed and the air flows into the first opening 422 smoothly. In contrast, the flow speed of the air is relatively small at the downstream portion 433d, therefore the air is not separated from the downstream portion 433d even when the curvature radius Rd is set relatively small. Furthermore, the protruding amount of the downstream portion 432d of the flange 432 can be set small by setting the curvature radius Rd relatively small. That is, according to the present embodiment, the flange 432 can be downsized and the turbulence of the air flowing into the first opening 422 can be suppressed. As a result, the flow speed of the air can be prevented from increasing locally in the first opening 422 and the fan suction port 210, whereby the noise and the flow resistance can be suppressed.

The annular protruding portion 431 has the upstream portion 431u and the downstream portion 431d located in the first introduction passage 420. The upstream portion 431u protrudes from the first opening 422 by the protruding amount Hu that is greater than the protruding amount Hd by which the downstream portion 431d protrudes from the first opening 422. That is, according to the present embodiment, the upstream portion 431u, where the flow speed of the air is relatively fast, protrudes by a relatively large amount, whereby the air can be certainly prevented from flowing into the first opening 422 directly. In contrast, the downstream portion 431d, where the flow speed of the air is relatively slow, protrudes by a relatively small amount, whereby the air flowing to the downstream of the annular protruding portion 431 positively flows into the first opening 422 directly. As a result, the flow speed of the air can be prevented from increasing locally in the first opening 422 and the fan suction port 210, whereby the noise and the flow resistance can be suppressed.

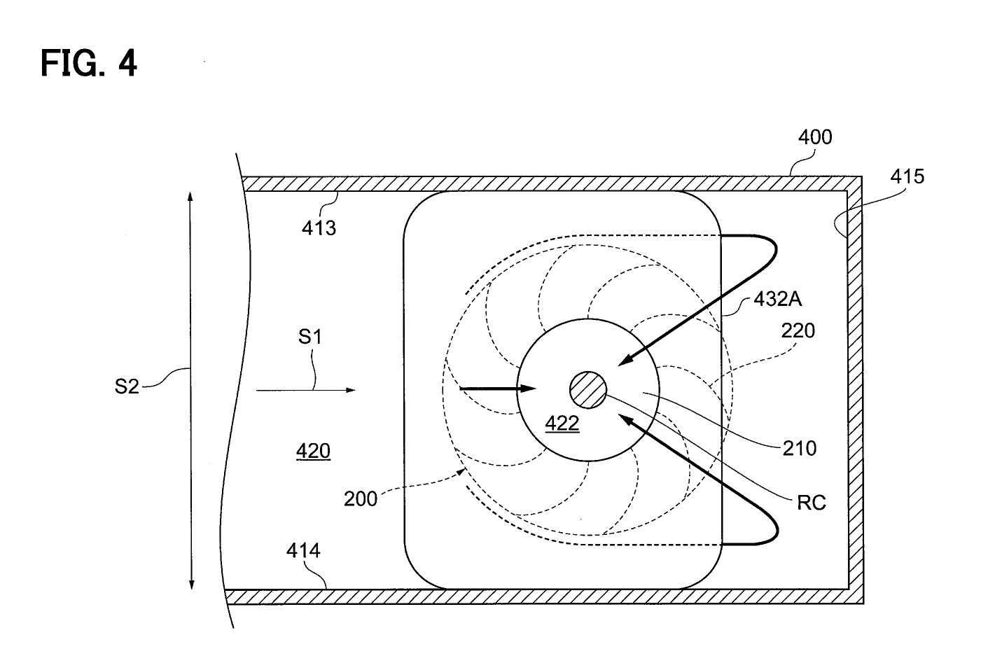

A modification of the present embodiment will be described hereafter referring to FIG. 4. The modification is different from the above-described embodiment in a point that the flange 432 is changed to a flange 432A and has a similar configuration as the above-described embodiment. The same component is thereby assigned with the same reference number, and an explanation is omitted.

FIG. 4 is a diagram corresponding to FIG. 3, which is the cross sectional view of the air conditioner 100 taken along a line III-III shown in FIG. 1, and illustrates a top view of the flange 432A. As shown in FIG. 4, the flange 432A has a rectangular shape in the top view.

The first introduction passage 420 has the inner wall surface 413 and the inner wall surface 414 facing each other in the direction S2 (i.e., the second direction). The inner wall surface 413 is one end in the direction S2 and the inner wall surface 414 is the other end in the direction S2. The flange 432A extends from the inner wall surface 413 to the inner wall surface 414 in the direction S2. That is, the flange 432A has one end and an other end that are in contact with the inner wall surface 413 and the inner wall surface 414 respectively. The second direction is perpendicular to both the rotational axis of the rotary shaft RC and the direction S1 (i.e., the first direction). The first introduction passage 420 has the inner wall surface 415 defining the downstream end of the first introduction passage 420. The flange 432A is distanced from the inner wall surface 415 in the direction S1.

According to the present modification, similar to the above-described embodiment, an upstream portion of the flange 432A protrudes from the first opening 422 by a protruding amount that is greater than a protruding amount of a downstream portion by which the downstream portion protrudes from the first opening 422.

Since the flange 432A is in contact with the inner wall surface 413 and the inner wall surface 414, e.g., there is no void between the flange 432A and each of the inner wall surface 413 and the inner wall surface 414, a volume of the air flowing from the first introduction passage 420 to the downstream of the annular protruding portion 431 in the direction S1 can be increased. As a result, the flow speed of the air can be prevented from increasing locally in the first opening 422 and the fan suction port 210, whereby the noise and the flow resistance can be suppressed.

The embodiments of the present disclosure are described above with specific examples. However, the present disclosure is not limited to the specific examples. That is, modifications that are made as required by a person having ordinary skill in the art based on the specific examples are included in a range of the present disclosure as long as having the features of the present embodiment. For example, elements mentioned in the specific examples, an arrangement, a material, a condition, a shape, a size, etc. of the elements are not limited to the specific examples, and can be changed as required.

What is claimed is:

1. An air conditioner for a vehicle, comprising
a centrifugal fan having a fan suction port and a rotary shaft and rotating centering on a rotational axis of the rotary shaft, the centrifugal fan drawing air from the fan suction port along the rotational axis and blowing the air in a radial direction; and
a housing having
a fan housing chamber that houses the centrifugal fan,
an introduction passage that guides air, which flows from an outside of the housing into the housing, to flow toward the centrifugal fan in a first direction intersecting with the rotational axis, and
a wall partitioning the fan housing chamber and the introduction passage from each other and having an opening that faces the fan suction port, wherein
the wall has a rim defining the opening and having an annular protruding portion, the annular protruding portion protruding from the wall toward the introduction passage and covering the opening, and
the annular protruding portion has a flange being distanced from the wall and protruding from the annular protruding portion in a direction away from the opening.

2. (canceled)

3. The air conditioner for a vehicle according to claim 1, wherein
the introduction passage has one end and an other end facing each other in a second direction, the second direction being perpendicular to both of the first direction and the rotational direction, and
the flange extends from the one end to the other end in the second direction.

4. The air conditioner for a vehicle according to claim 1, wherein
the flange has an upstream portion and a downstream portion, and
the upstream portion protrudes from the opening by a protruding amount that is greater than a protruding amount by which the downstream portion protrudes from the opening.

5. The air conditioner for a vehicle according to claim 1, wherein
the annular protruding portion includes an end part being located adjacent to the introduction passage and having a curved portion,
the curved portion has a curved shape in which curvature radiuses vary depending on positions of the curved portion,
the curved portion has an upstream portion and a downstream portion, the upstream portion being located upstream of the downstream portion in the introduction passage, the downstream portion being located downstream of the upstream portion in the introduction passage, and
a curvature radius of the upstream portion is greater than a curvature radius of the downstream portion.

6. (canceled)

7. (canceled)

8. The air conditioner for a vehicle according to claim 1, wherein
the annular protruding portion has an upstream portion and a downstream portion, the upstream portion being located upstream of the downstream portion in the introduction passage, the downstream portion being located downstream of the upstream portion in the introduction passage, and
the upstream portion protrudes from the opening by a protruding amount that is greater than a protruding amount by which the downstream portion protrudes from the opening.

9. (canceled)
